(19) United States
(12) Patent Application Publication
(10) Pub. No.: US 2008/0012383 A1
(43) Pub. Date: Jan. 17, 2008

(54) Method for Bonding a Glazing

(76) Inventor: Philip R. Larson, Scandia, MN (US)

Correspondence Address: 3M INNOVATIVE PROPERTIES COMPANY, PO BOX 33427, ST. PAUL, MN, 55133-3427, US

(21) Appl. No.: 11/572,963

(22) PCT Filed: Jul. 15, 2005
(86) PCT No.: PCT/US05/25154

§ 371 Date: Jan. 30, 2007

Related U.S. Application Data
(60) Provisional application No. 60/598,615, filed on Aug. 4, 2004.

(51) Int. Cl. B60J 10/02

(52) U.S. Cl. 296/93; 156/295

(57) ABSTRACT

A method of bonding a glazing to a vehicle frame is disclosed. The method includes the steps of applying at least one segment of pressure-sensitive adhesive material to the vehicle frame and applying a quantity of sealant material to the vehicle frame.

### FIELD

The present invention relates to sealing two substrates together, particularly when one of the substrates is glass.

### BACKGROUND

Many applications require bonding or securing a glass substrate to a material such as wood, metal, or plastic. For example, glass windshields, often referred to as glazings, may be secured to the frame of an automobile during original vehicle manufacture and following manufacture to replace a broken or damaged windshield. During the original manufacturing process, automobile windshields are typically secured in place by an automated process. When a broken or damaged windshield is replaced in the automotive aftermarket industry, the windshields are replaced manually, which creates many problems not encountered in the original manufacture.

In addition, there is an increasing need to repair windshields quickly in the automotive aftermarket. Windshields that are replaced in the automotive aftermarket industry are typically secured in place by the use of polyurethane pastes, which are applied to the frame of the vehicle to establish a seal between the windshield and the frame. A significant drawback to the use of polyurethane pastes is that they require a relatively long time to cure or build bond strength. Conventional polyurethane sealant materials require an average of about twenty-four hours to fully cure. Cure time may additionally be affected by ambient moisture and temperature, making the exact cure time unpredictable. During the curing period, the glass can vibrate within the frame, making the seal and the glass susceptible to damage. Further, gaps in the seal can form giving rise to wind noise and poor seal strength and integrity.

To address these issues, a number of sealants that require shorter cure times have been developed, however, such products tend to be extremely viscous, which limits product shelf life and makes the products very difficult to use.

It is therefore desirable to provide a method of sealing a windshield that addresses these and other problems.

### SUMMARY

The present invention relates to a method of installing a vehicle glazing. The method of the present invention enables the installation of a vehicle glazing utilizing a pressure sensitive adhesive in conjunction with a sealant material. The pressure sensitive adhesive provides an initial bond while the sealant material cures, which cuts down on the total repair time. In an embodiment, the method comprises the steps of:
(a) providing a vehicle, said vehicle having a frame, said frame having a surface for receiving a glazing;
(b) providing at least one segment of pressure-sensitive adhesive material and applying said segment of pressure-sensitive adhesive material to the surface for receiving a glazing;
(c) applying a quantity of sealant material to the surface for receiving a glazing, adjacent the at least one segment of pressure-sensitive adhesive material; and
(d) securing a glazing onto the segment of pressure-sensitive adhesive material and sealant material, bonding the glazing to the vehicle.

In a further embodiment, the invention relates to a vehicle comprising:
(a) a vehicle frame, said frame having a surface for receiving a glazing;
(b) at least one segment of pressure-sensitive adhesive material adhered to the surface for receiving a glazing;
(c) a quantity of sealant material applied to the surface for receiving a glazing adjacent the segment of pressure-sensitive adhesive material; and
(d) a glazing secured to the pressure-sensitive adhesive material and sealant material, wherein the glazing is bonded to the vehicle.

A “Pressure Sensitive Adhesive (PSA)” as defined by the Pressure Sensitive Adhesive Tape Counsel (PSTC), Glenview, Ill., is an adhesive that is aggressively and permanently tacky and will firmly adhere to a wide variety of dissimilar surfaces upon mere contact and without the need for more than finger or hand pressure. A PSA requires no activation by water, solvent or heat in order to exert a strong adhesive holding force toward materials such as paper, glass, plastic, wood, cement and metals.

“Sealant Material” as used herein means a moisture-curable composition which, when cured, exhibits strong adhesion to a variety of substrates, such as paper, glass, plastic, wood, cement and metals.

“Glazing” as used herein is a window other glass used in an automobile, truck, train or other vehicle, including the windshield, side windows, rear window and sunroof.

### BRIEF DESCRIPTION OF THE DRAWINGS

FIG. 1 is an enlarged, fragmentary cross-sectional view of a pressure sensitive adhesive material in one embodiment of the invention;

FIG. 2 is a perspective view illustrating the installation of a windshield onto a motor vehicle in one embodiment of the invention;

FIG. 3 is a perspective view illustrating the installation of a windshield onto a motor vehicle in one embodiment of the invention;

FIG. 4 is a perspective view illustrating the installation of a windshield onto a motor vehicle in one embodiment of the invention;

FIG. 5 is a perspective view illustrating the installation of a windshield onto a motor vehicle in one embodiment of the invention:

FIG. 6 is a perspective view illustrating the installation of a windshield onto a motor vehicle in one embodiment of the invention.

### DETAILED DESCRIPTION OF THE PREFERRED EMBODIMENTS

The present invention is directed to a method of installing a vehicle glazing. The method of the present invention enables the installation of a vehicle glazing utilizing a pressure sensitive adhesive in conjunction with a sealant material.

United States Federal Transportation Agency regulations require windshields to remain in place during crashes of up to 30 mph (48 km/h). Federal Motor Vehicle Safety Standards (FMVSS) 208 and 212 describe certain requirements which are pertinent to automotive windshield replacements. In particular, these standards set forth the minimum performance characteristics required of a windshield retention system.

The pressure sensitive adhesive disclosed herein provides an initial bond sufficient to meet the FMVSS 208 and 212 while the sealant material cures, and ultimately reaches the Original Equipment Manufacturer (OEM) specified bond strength for a fully cured sealant.

In an embodiment, the invention is directed to a method of installing a vehicle glazing comprising the steps of:
a. providing a vehicle, the vehicle having a frame, said frame having a surface for receiving a glazing;
b. providing at least one segment of pressure-sensitive adhesive material and applying said segment of pressure-sensitive adhesive material to the surface for receiving a glazing;
c. applying a quantity of sealant material to the surface for receiving a glazing, adjacent the at least one segment of pressure-sensitive adhesive material; and
d. securing a glazing onto the segment of pressure-sensitive adhesive foam material and sealant material, bonding the glazing to the vehicle.

Turing now to the drawings, FIGS. 2-6 illustrate a car 20 having a windshield 22 replaced by a method according to an embodiment of the present invention. In this embodiment, the windshield 22 is first “dry-fitted”, or set in place without sealant or adhesive, to the pinchweld 24 of the car frame 26. Once the windshield 22 is positioned and aligned in place, segments of tape 28 are placed on the windshield 22 and car frame 26 to mark the position where the windshield will be placed (FIG. 3). The segments of tape 28 are then cut along the edge of the windshield 30 between the windshield 22 and car frame 26. The respective segments of tape 28 left on the windshield 22 and car frame 26 provide a means of aligning the windshield in place once the adhesive and sealant materials are applied to the pinchweld 24.

Prior to adhering the windshield 22 to the car frame 26, the windshield may optionally be treated with a primer, applied to the contact surface between the windshield and the sealant and PSA material, to facilitate adhesion. Suitable primers for use with the invention are commercially available under the trade designations “Single Step Primer” or “Clear Primer (Step 1)” and “Black Primer (Step 2)” from the 3M Company, St. Paul Minn. It is important to handle the windshield 22 carefully during installation as the presence of even small amounts of dirt, debris, oil, etc., can interfere with the bond of the windshield to the PSA and sealant material. Thus it is important that installers take great care to preserve the integrity of bonding surfaces when installing windshields.

After any remaining material is removed from the pinchweld 24, a segment of the PSA material 40 is adhered to the pinchweld. Ideally, the PSA material 40 is provided with a release liner to protect against extraneous contact, which may act to weaken the effectiveness of the adhesive. Segments of the PSA material 40 may be applied end-to-end in a continuous fashion along the pinchweld 24, or alternatively, discrete segments may be intermittently applied along the pinchweld 24.

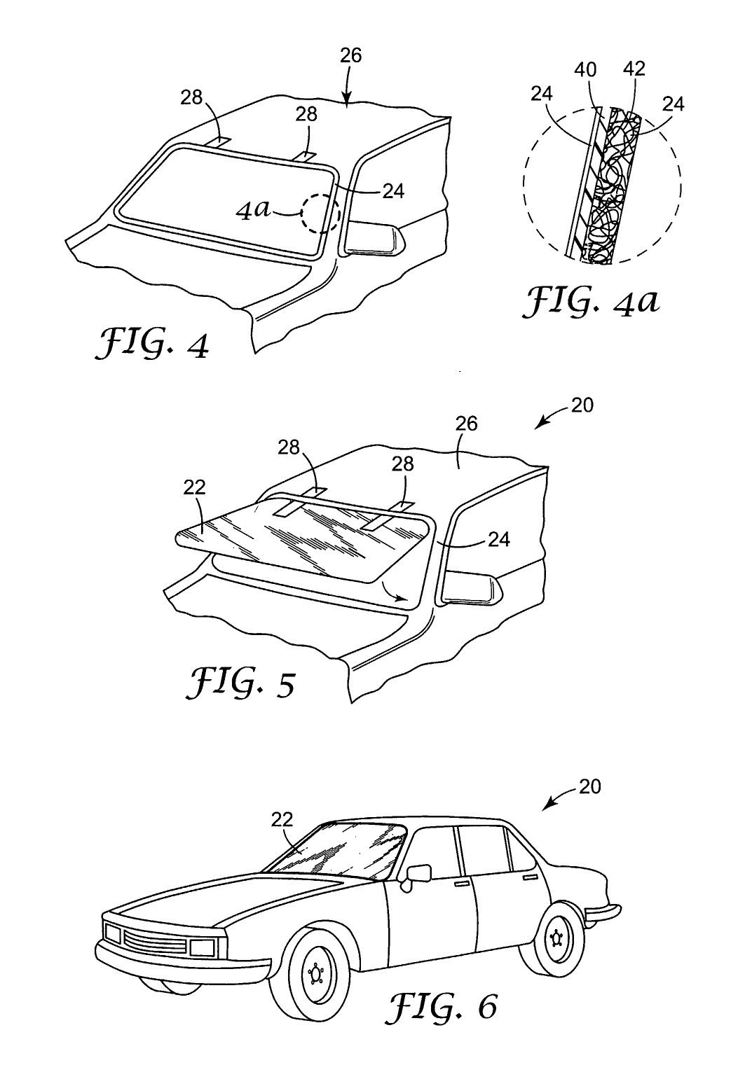

Adjacent to the PSA material 40, a bead or quantity of sealant material 42 is placed on the pinchweld 24. When replacing a glazing previously bonded with a urethane sealant, a thin film (1-2 mm) of old urethane may, optionally, be left on the pinchweld 24, and the new urethane sealant material is placed over the thin film of old urethane material. For the purposes of ensuring an air-tight and water-tight seal, the sealant material should be applied in a continuous fashion along the pinchweld 24, either to the outside or inside of the PSA material 40. In the embodiment illustrated in FIG. 4, the sealant material 42 is placed to the outside of the PSA material 40.

With the sealant material 42 and PSA material 40 in place, the windshield 22 (which has optionally been primed) is positioned in the pinchweld 24 by aligning the segments of tape 28 previously placed on the windshield 22 and car frame 26 (FIG. 5). In this step, care should be taken to insert the windshield so that it does not come into contact with the PSA material or sealant material until proper alignment has been achieved. Once aligned, the windshield 22 is carefully lowered into place and gentle pressure is applied to ensure full contact with the sealant material 42 and PSA material 40. Once the segments of tape 28 are removed, the windshield 22 is fully installed (FIG. 6). The PSA material 40 provides sufficient green strength to meet FMVSS standards until the sealant material has fully cured. The PSA foam material also advantageously provides a means to maintain uniform spacing between the windshield 22 and the pinchweld 24, which ensures that the sealant material forms a uniform bond along the entire surface of the pinchweld 24.

The PSA material utilized in the present invention may be chosen from a variety of aggressively bonding PSAs. In an embodiment, the pressure sensitive adhesive is in the form of an acrylic foam tape. In a further embodiment, a polyurethane foam tape is used. Polyurethane foam tapes are commercially available under the trade designations Thermalbond V2100 and T-Bond II from the Norton Plastics Corporation, Grandville N.Y. The pressure sensitive adhesive material of the present invention advantageously does not need to be cured with heat or radiation in order to form a bond.

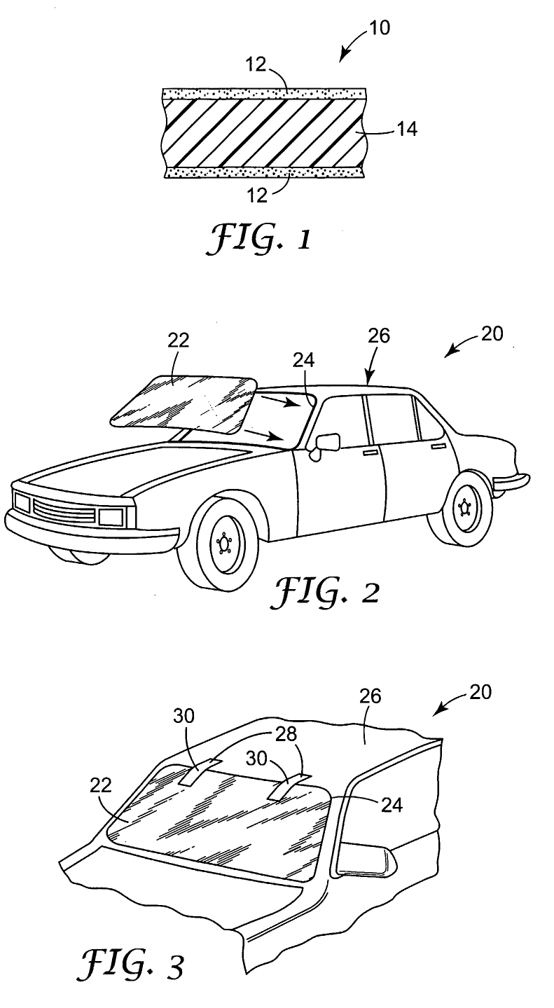

FIG. 1 illustrates a PSA material 10 utilized in an embodiment of the present invention (note that the sealant material of FIG. 1 is not drawn to scale). The PSA material 10 has adhesive layers 12 on opposing sides of a central core 14 of a rubber or polymeric material. In an embodiment, the core material is in the form of a polymeric foam. In other embodiments, the PSA material may completely comprised of an adhesive material such that a separate layer of adhesive would not be necessary (not illustrated).

The PSA material may be provided in a variety formats for use with in the method of the present invention. In an embodiment, the PSA material is in the form of segments of material about 5/16″ in height by about ¼″ in width, by about 1 to 2 inches in length. In a further embodiment, segments of PSA material are about ⅜″ in height, by about ¼″ in width, by about 1 to 2 inches in length. In yet a further embodiment, the PSA material is in the form of segments of material about ¼″ in height, by about ¼″ wide, by about 1 to 2 inches in length. The PSA material may be provided in a variety of other shapes and sizes, as appropriate for the application. In an embodiment, a length of the PSA material is provided in a roll, in which the layers may be separated by a release liner.

Examples of suitable pressure sensitive adhesive materials are described in WO 00/06637, U.S. Pat. No. 6,630,531, and U.S. Pat. No. 6,586,483. A further example of a pressure sensitive adhesive is described in U.S. Patent Publication No. 20030190468.

In an embodiment, the PSA material is an acrylic polymer foam article as described in WO 00/06637. The foam includes a plurality of microspheres at least one of which is an expandable polymeric microsphere.

As used herein, a “polymer foam” refers to an article that includes a polymer matrix in which the density of the article is less than the density of the polymer matrix alone. In an embodiment, the polymeric foam material has a substantially smooth surface, which facilitates seamless adhesion to a substrate.

A “substantially smooth” surface refers to a surface having an Ra value less than about 75 micrometers, as measured by laser triangulation profilometry. In an embodiment, the surface has an Ra value less than about 50 micrometers, in a further embodiment, the surface has an Ra value less than about 25 micrometers. The surface is also characterized by the substantial absence of visually observable macroscopic defects such as wrinkles, corrugations and creases. In addition, the surface is sufficiently smooth such that it exhibits adequate contact and, thereby, adhesion to a substrate of interest.

An “expandable polymeric microsphere” is a microsphere that includes a polymer shell and a core material in the form of a gas, liquid, or combination thereof, that expands upon heating. Expansion of the core material, in turn, causes the shell to expand, at least at the heating temperature. An expandable microsphere is one where the shell can be initially expanded or further expanded without breaking. Some microspheres may have polymer shells that only allow the core material to expand at or near the heating temperature.

The polymer foam PSA material may be constructed in one of two ways. The polymer foam itself may be an adhesive, or the polymer foam material may include one or more separate adhesive compositions bonded to the foam, e.g., in the form of a continuous layer or discrete structures (e.g., stripes, rods, filament, etc.), in which case the foam itself need not be an adhesive.

The polymer foam PSA preferably is substantially free of urethane crosslinks and urea crosslinks, thus eliminating the need for isocyanates in the composition. An example of a material suitable for making the polymer foam is an acrylic polymer or copolymer. In some cases, e.g., where high cohesive strength and/or high modulus is needed, the foam may be crosslinked.

The polymer foam preferably includes a plurality of expandable polymeric microspheres. The foam may also include one or more non-expandable microspheres, which may be polymeric or non-polymeric microspheres (e.g., glass microspheres). Examples of expandable polymeric microspheres suitable for use in the polymer foam material include those in which the shell is essentially free of vinylidene chloride units. Preferred core materials are materials other than air that expand upon heating.

The foam may contain agents in addition to microspheres. Examples of suitable agents include those selected from the group consisting of tackifiers, plasticizers, pigments, dyes, solid fillers, and combinations thereof. The foam may also include gas-filled voids in the polymer matrix. Such voids typically are formed by including a blowing agent in the polymer matrix material and then activating the blowing agent, e.g., by exposing the polymer matrix material to heat or radiation.

It can be desirable for the foam to comprise a substantially uncrosslinked or thermoplastic polymeric matrix material. It can also be desirable for the matrix polymer of the foam to exhibit some degree of crosslinking. One potential advantage to such crosslinking is that the foam will likely exhibit improved mechanical properties (e.g., increase cohesive strength) compared to the same foam with less or no crosslinking.

In an embodiment, the PSA material comprises a polymer foam that includes: (a) a plurality of microspheres, at least one of which is an expandable polymeric microsphere (as defined above), and (b) a polymer matrix that is substantially free of urethane crosslinks and urea crosslinks. The matrix includes a blend of two or more polymers in which at least one of the polymers in the blend is a pressure sensitive adhesive polymer (i.e., a polymer that is inherently pressure sensitive, as opposed to a polymer which must be combined with a tackifier in order to form a pressure sensitive composition) and at least one of the polymers is selected from the group consisting of unsaturated thermoplastic elastomers, acrylate-insoluble saturated thermoplastic elastomers, and non-pressure sensitive adhesive thermoplastic polymers.

The PSA material is suitable for bonding to a variety of substrates. Examples of suitable substrates include wood substrates, glass substrates, synthetic polymer substrates, and metal substrates (e.g., metal foils).

The PSA material may be prepared by: (a) melt mixing a polymer composition and a plurality of microspheres, one or more of which is an expandable polymeric microsphere (as defined above), under process conditions, including temperature, pressure and shear rate, selected to form an expandable extrudable composition; (b) extruding the composition through a die to form a polymer foam (as defined above); and (c) at least partially expanding one or more expandable polymeric microspheres before the polymer composition exits the die. It may be preferable for most, if not all, of the expandable microspheres to be at least partially expanded before the polymer composition exits the die. By causing expansion of the expandable polymeric microspheres before the composition exits the die, the resulting extruded foam can be produced to within tighter tolerances.

It is desirable for the PSA material to be substantially solvent-free. In an embodiment, the PSA material contains less than 20 wt. % solvent, in a further embodiment, the material contains substantially none to no greater than about 10 wt. % solvent and, and in yet a further embodiment, the material contains no greater than about 5 wt. % solvent.

The PSA material may possess a weight average molecular weight of at least about 10,000 g/mol in one embodiment, and at least about 50,000 g/mol, in a further embodiment. The polymers used to fabricate the PSA material may exhibit shear viscosities measured at a temperature of 175° C. and a shear rate of 100 sec⁻¹, of at least about 30 Pascal-seconds (Pa-s), in one embodiment, at least about 100 Pa-s in a further embodiment, and at least about 200 Pa-s in yet a further embodiment.

The PSA foam material may also be crosslinked. For example, the foam may be exposed to thermal, actinic, or ionizing radiation or combinations thereof subsequent to extrusion to crosslink the foam. Crosslinking may also be accomplished by using chemical crosslinking methods based on ionic interactions.

Additives such as ultraviolet-absorbing pigments (e.g., black pigments), dyes, and tackifiers may be added to the PSA foam material. These additives could not be used effectively in actinic radiation-based foam processes. It is further possible, in contrast to solvent-based and actinic radiation-based foam processes, to prepare foams having a substantially homogeneous distribution of microspheres. In addition, the expanded foam (i.e., a foam containing microspheres that have been at least partially expanded) can have a uniform size distribution of the expanded microspheres from the surface to the center of the foam. Uniform distribution of the microspheres contributes to stronger mechanical properties in the foam.

Foams with a substantially smooth surface can be produced in a single step. Accordingly, it is not necessary to bond additional layers to the foam in order to achieve a smooth-surfaced article.

The extrusion process enables the preparation of multi-layer articles, or articles with discrete structures, in a single step. In addition, when foaming occurs during the extrusion, it is possible, if desired, to eliminate separate post-production foaming processes. Moreover, by manipulating the design of the extrusion die (i.e., the shape of the die opening), it is possible to produce foams having a variety of shapes.

In addition, the method of making the PSA foam material may include heating the article after extrusion to cause further expansion. The additional expansion may be due to microsphere expansion, activation of a blowing agent, or a combination thereof.

It is also possible to prepare “foam-in-place” articles by controlling the process temperature during the initial foam preparation such that expansion of the microspheres is minimized or suppressed. The article can then be placed at a location of use or application, (e.g., in a recessed area or on an open surface) and heated, or exposed to an elevated temperature to cause microsphere expansion. “Foam-in-place” articles can also be prepared by including a blowing agent in the expandable extrudable composition and conducting the extrusion process under conditions insufficient to activate the blowing agent. Subsequent to foam preparation, the blowing agent can be activated to cause additional foaming.

The sealant material utilized in an embodiment of the present invention may be a moisture-curable polyurethane adhesive, an example of which is described in U.S. Pat. No. 4,539,345. Further examples of sealant materials suitable for use in the present invention are commercially available under the trade designations “Medium Viscosity Auto Glass Urethane Windshield Adhesive” and “Fast Cure Auto Glass Urethane” from 3M Company, St. Paul Minn.

While the invention has been described with reference to the particular embodiments and drawings as set forth above, the spirit of the invention is not so limited and is defined by the appended claims.

What is claimed is:

1. A method of installing a vehicle glazing, comprising the steps of:
a. providing a vehicle, said vehicle having a vehicle frame, said frame having a surface for receiving a glazing;
b. providing at least one segment of pressure-sensitive adhesive material and applying said segment of pressure-sensitive adhesive material to the surface for receiving a glazing;
c. applying a quantity of sealant material to the surface for receiving a glazing, adjacent the at least one segment of pressure-sensitive adhesive material; and
d. securing a glazing onto the segment of pressure-sensitive adhesive material and sealant material, bonding the glazing to the vehicle.

2. The method of claim 1, wherein the sealant material is cured.

3. The method of claim 1, wherein the sealant material is a urethane adhesive.

4. The method of claim 1, wherein the pressure-sensitive adhesive material is a polymer foam tape selected from the group consisting of: an acrylic foam and a urethane foam.

5. The method of claim 1 wherein the pressure sensitive adhesive is not thermoset or cured.

6. The method of claim 4, wherein the pressure-sensitive adhesive material is an acrylic foam.

7. A vehicle comprising:
a. a vehicle frame, said frame having a surface for receiving a glazing;
b. at least one segment of pressure-sensitive adhesive material adhered to the surface for receiving a glazing;
c. a quantity of sealant material applied to the surface for receiving a glazing adjacent the segment of pressure-sensitive adhesive material; and
d. a glazing secured to the pressure-sensitive adhesive material and sealant material, wherein the glazing is bonded to the vehicle.

8. The vehicle of claim 7, wherein the sealant material is cured.

9. The vehicle of claim 7, wherein the sealant material is a urethane adhesive.

10. The vehicle of claim 7, wherein the pressure-sensitive adhesive material is a polymer foam tape selected from the group consisting of: an acrylic foam and a urethane foam.

11. The vehicle of claim 10, wherein the pressure-sensitive adhesive material is an acrylic foam.

12. The vehicle of claim 7, wherein the pressure sensitive adhesive is not thermoset or cured.
